(19) United States
(12) Patent Application Publication
(10) Pub. No.: US 2024/0417278 A1
(43) Pub. Date: Dec. 19, 2024

(54) Gravity Filter Cap for Water Bottle

(71) Applicant: Allen YU, Compton, CA (US)

(72) Inventor: Allen YU, Compton, CA (US)

(21) Appl. No.: 18/210,595

(22) Filed: Jun. 15, 2023

(51) Int. Cl. C02F 1/00; B01D 29/33; B01D 35/30; B01D 37/00; B65D 51/24

(52) U.S. Cl. CPC C02F 1/003; B01D 29/33; B01D 35/30; B01D 37/00; B65D 51/24; B01D 2201/347; C02F 2307/10

(57) ABSTRACT

A gravity filter cap is adapted for covering a bottle opening of a water bottle and filtering the water contained in the water bottle before dispensing through the bottle opening. The gravity filter cap includes a bottle cap which is configured to detachably connected with a filter arrangement to be inwardly extended from the bottle opening into the water bottle when the bottle cap is mounted on the bottle opening so as to ensure the water to be filtered before dispensing through a water outlet of the bottle cap when the water bottle is placed in an inverted or slop-downward dispensing position.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to water bottle cap, and more particularly to a gravity filter cap with filter arrangement to replace the original bottle cap of water bottle to be used with dispenser device or portable dispenser.

### Description of Related Arts

Purified water commonly used in home and office is delivered with larger water bottle, for example the 2-5 gallons water jug as shown in FIGS. 1A and 1B, wherein the original bottle cap is opened and replaced with a reuseable dispensing cap, as shown in FIG. 1C, having an outlet opening such that the water bottle can be delivered to be consumed by means of a dispenser device as shown in FIG. 1A or a dispenser stand to support the water bottle in an inverted position while a portable dispenser is connected to the dispensing cap as shown in FIG. 1B.

However, before the bottles of purified water are delivered to the user's homes or offices, there is no guarantee of the bottles of water are stored and transported in a cool and dry environment for maintaining the preferred purified water quality. Since the water bottles and jugs are made of plastic, it is known that the contained water may be reacted with the plastic material of the bottle or jug under high temperature, such as being exposed under the hot summer sunlight, and leach harmful chemicals into the contained water that may cause health hazards to the users who consume the contained water. For example, polyethylene terephthalate bottles, which are commonly used for water bottles, may release the chemicals antimony and phthalates when exposed to high temperature, wherein antimony is a toxic metal that can cause nausea, vomiting, and diarrhea and phthalates are endocrine disruptors that may interfere with hormone levels in the body. Polycarbonate plastic made water bottle can release bisphenol A when exposed to heat that is a known endocrine disruptor that has been linked to a variety of health problems.

ChatGPT suggests some methods to filter contained water of a 5-gallon water bottle:
1. Pour the water from the 5-gallon bottle into a water filtration pitcher or a gravity water filter.
2. Place the 5-gallons bottle on top of a gravity-fed water filter or a countertop water filter or using a hose or tubing to remove impurities form the water.
3. Connect a reverse osmosis system to the 5-gallon water bottle using a hose or tubing to remove impurities from the water.

Such filtration devices, such as gravity-fed water filter, countertop water filter and reverse osmosis system, are options to be used in home or office, but especially not practical and efficient in outdoor activities such as camping, fishing and hunting for the user to filter the water obtained at nearby water sources. It is not only inconvenient to carry an extra filtration device beside the water bottle to store the water, but also much troublesome to operate the filtration device for water consumption every time to the user.

### SUMMARY OF THE PRESENT INVENTION

The invention is advantageous in providing a gravity filter cap which is configured to be mounted on the bottle opening of a water bottle and filter water contained in the water bottle while dispensing through the outlet opening of the filter cap.

Another advantage of the invention is to provide a gravity filter arrangement built-in a bottle cap to be mounted on the bottle opening of a water bottle which is configured to equip one or more filter elements between a water inlet and a water outlet of the filter arrangement so as to filter water contained in the water bottle flowing through the water inlet, the water outlet and the outlet opening of the bottle cap of the gravity filter cap.

Another advantage of the invention is to provide a gravity filter cap which is capable of separating chemicals and/or particles from the water contained in the water bottle using the force of gravity to pull the water through one or more filter elements, including but not limited to filter paper, filter particles, ceramic and/or activated charcoal. When filter paper or particles are used as the filter elements, solid particles in the contained water are trapped on the surface of the filter elements while the filtered liquid can be passed through due to the force of gravity.

Another advantage of the invention is to provide a gravity filter cap adapted to be mounted on the top bottle opening of a water bottle such that when the water bottle is placed in an inverted or slope-downward position for water dispensing, the filter arrangement is upwardly extended from the bottle cap towards a bottom of the water bottle so as to position the filter elements closest to the bottle opening and ensure the filter arrangement being immersed in immediate water to be dispensed, such that while water is dispensing through the gravity filter cap, the water around the filter arrangement, i.e. the water to be dispensed, is forced by gravity to pass through the gravity filter cap and be filtered properly and effectively.

Another advantage of the invention is to provide a gravity filter cap comprising a bottle cap and a filter arrangement connected to the bottle cap in such a manner that the filter arrangement is further secured to the bottle cap by the water pressure applied thereto due to gravity.

Another advantage of the invention is to provide a gravity filter cap which filter arrangement is detachably secure to the bottle cap so that when the water bottle and its contained water are well stored in a cool and dry environment, the user may detach the filter arrangement to skip the filtration function and simply use the bottle cap as a conventional cap.

Another advantage of the invention is to provide a gravity filter cap which has a simple configuration to ensure a relatively low manufacturing cost while allowing the one or more filter elements to be replaceable easily.

Another advantage of the invention is to provide a gravity filter cap which filter arrangement comprises a gravity presser configured to ensure the filter element tightly mounted at the water outlet thereof to ensure proper filtration while the water bottle is placed in an inverted or slope-downward dispensing position by means of water pressure due to gravity.

Additional advantages and features of the invention will become apparent from the description which follows, and may be realized by means of the instrumentalities and combinations particular point out in the appended claims.

According to the present invention, the foregoing and other objects and advantages are attained by a gravity filter cap, adapted for a water bottle which comprises a bottle body which has a bottle opening at a top end thereof, comprising:
a bottle cap comprising a ring shaped ceiling wall having a cap opening, a circular outer rim integrally extended from a circular outer edge of the ceiling wall and configured to be mounted on the bottle opening of the water bottle; and
a filter arrangement comprising:
a tubular inner connector integrally and inwardly extended around the cap opening of the bottle cap to define a water outlet of the bottle cap and form an outer mounting surface thereon;
an elongated hollow cylindrical cartridge shell comprising a first end wall at a first end thereof, a second end wall at a second end thereof, a tubular secure head inwardly formed and extended from the second end wall and configured to be detachably and sealedly connected with the inner connector so as to coaxially couple the cartridge shell with the bottle cap, and a tubular surrounding shell body extending between the first end and second end thereof and defining a water inlet, having a plurality of surrounding water holes spacedly and radially formed around the surrounding shell body of the cartridge shell and a receiving chamber extended between the first end wall and the second end wall inside the cartridge shell and communicating with outside through the plurality of water holes adapted for water contained in the water bottle to enter the receiving chamber via the plurality of surrounding water holes, such that when the secure head of the cartridge shell is connected with the inner connector of bottle cap, the water outlet of the cartridge shell is coaxially aligned with the cap opening;
at least one filter element disposed in the receiving chamber; and
means for holding the at least one filter element in position within the receiving chamber of the cartridge shell in such a manner that one end of the at least one filter element is securely coupled with the water outlet of bottle cap to ensure the water entered through the water inlet of the cartridge shell to pass through the at least one filter element and dispense through the water outlet of the bottle cap when the water bottle is in an inverted or slop-downward dispensing position, thereby the gravity filter cap is arranged correspondingly in a dispensable condition that the bottle opening is directed downward and the filter arrangement is upwardly extended from the bottle cap to ensure the filter arranging being immersed in the water around the filter arrangement which is forced by gravity to pass through the at least one filter element to be filtered before dispensing through the water outlet of the cartridge shell and the cap opening of the bottle cap.

In one embodiment, the gravity filter cap further comprises a filter cartridge containing the at least one filter element for mounting in the receiving chamber in filtering position.

In one embodiment, the holding means comprises a holder member configured to securely couple one end of the at least one filter element with the water outlet of bottle cap to ensure the water entered through the water inlet of the cartridge shell to pass through the at least one filter element and dispense through the water outlet of the bottle cap.

In one embodiment, the gravity filter cap further comprises a dispenser faucet configured to be sealedly connected to the bottle cap to selectively normally close the cap opening and open the cap opening to dispense the water contained in the water bottle to flow out through the cap opening and the dispenser faucet.

In one embodiment, the water outlet is an outlet channel defined by the inner connector of the bottle cap and coaxially extended from the cap opening of the bottle cap into the receiving chamber of the cartridge shell via the inner connector when the bottle cap is securely connected with the cartridge shell, wherein the outlet channel is configured to receive a tubular inserter of the dispenser faucet.

In one embodiment, the dispenser faucet comprises an insert tube fittingly inserted in the inner connector of the bottle cap.

In one embodiment, the gravity filter cap further comprises a ring shape sealer to be positioned between the bottle cap and a bottle opening edge of the water bottle to provide a water sealing effect.

In accordance with another aspect of the invention, the present invention provides a method of filtering and dispensing water contained in a water bottle, comprising:
(a) providing a bottle cap of a gravity filter cap at a bottle opening of a water bottle which is directed downward allowing a water contained in the water bottle trending to flow out through the bottle opening;
(b) aligning a water outlet of a filter arrangement of the gravity filter cap with a cap opening coaxially aligned with the bottle opening; and
(c) holding at least one filter element against the water outlet to ensure the water contained in the water bottle to enter the filter arrangement through a water inlet which has a plurality of surrounding holes spacedly formed around a circular surrounding shell body of an elongated cylindrical cartridge shell of the filter arrangement and be forced to pass through the at least one filter element due to gravity before dispensing the water contained in the water bottle via the water outlet, the cap opening and the bottle opening.

In one embodiment, the method further comprises a step of controlling a flow of water contained in the water bottle via the cap opening by a dispenser faucet mounted to the bottle cap of the gravity filter cap.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A is a perspective view of a conventional dispenser device for a water bottle mounted thereon in an inverted position.

FIG. 1B is a perspective view of a conventional dispenser stand for a water bottle mounted thereon in a slope-downward position.

FIG. 1C is a perspective view of a conventional bottle cap having a cap opening therein and an opening cover adapted to be mounted to the bottle opening of the water bottle.

FIG. 2 is a perspective view of a gravity filter cap for water bottle according to a preferred embodiment of the present invention.

FIG. 3 is an exploded perspective view of the gravity filter cap according to the above preferred embodiment of the present invention.

FIG. 4 is a sectional view of the bottle cap and the cartridge shell of the gravity filter cap according to the above preferred embodiment of the present invention.

FIG. 5A is a schematic view of a first filter element of the filter arrangement of the gravity filter cap according to the above preferred embodiment of the present invention.

FIG. 5B is a schematic view of a second filter element of the filter arrangement of the gravity filter cap according to the above preferred embodiment of the present invention.

FIG. 5C is a partial exploded schematic view of a filter cartridge of the filter arrangement of the gravity filter cap according to the above preferred embodiment of the present invention.

FIG. 6 is a sectional view of the gravity filter cap according to the above preferred embodiment of the present invention.

FIG. 7 is a sectional view illustrating a first alternative mode of the filter element secured in the cartridge shell of the gravity filter cap of the gravity filter cap according to the above preferred embodiment of the present invention.

FIG. 8 is a sectional view illustrating a second alternative mode of the filter element secured in the cartridge shell of the gravity filter cap of the gravity filter cap according to the above preferred embodiment of the present invention.

FIG. 9 is a sectional view illustrating a third alternative mode of the filter element secured in the cartridge shell of the gravity filter cap of the gravity filter cap according to the above preferred embodiment of the present invention.

FIG. 10 is a perspective view of an alternative mode of the bottle cap of the gravity filter cap according to the preferred embodiment of the present invention.

FIG. 11 is a perspective view of a dispenser faucet and the bottle cap of the gravity filter cap according to the above preferred embodiment of the present invention.

FIG. 12 is a perspective view illustrating the gravity filter cap mounted to a bottle opening of a water bottle supported in a slop-downward position by a dispenser stand according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

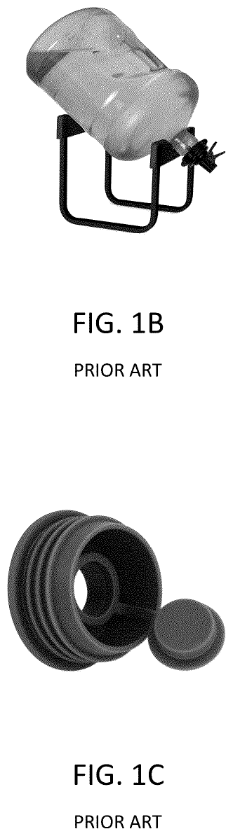

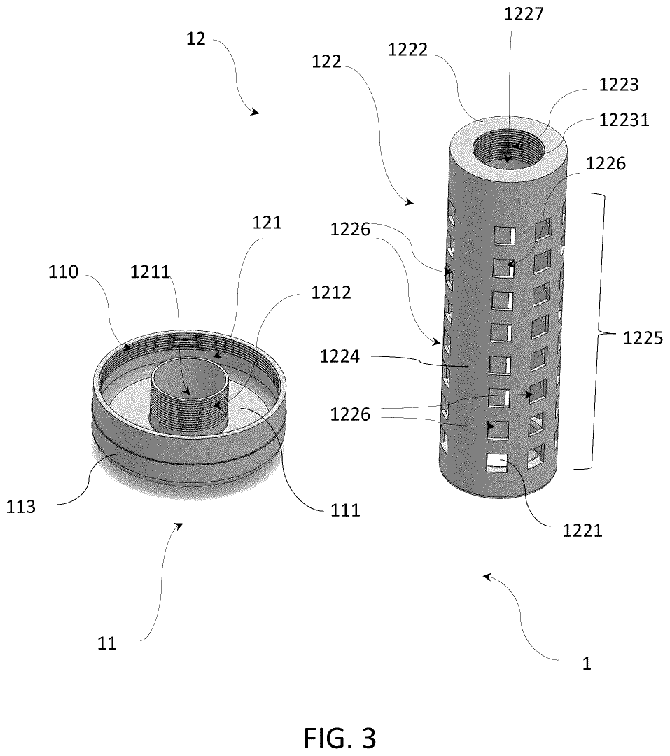

Referring to FIG. 2 to FIG. 4, a gravity filter cap 1 according to a preferred embodiment is illustrated. The gravity filter cap 1 is adapted for a water bottle 2 which comprises a bottle body 21 which has a bottle opening 22 at a top end thereof (as shown in FIG. 4)

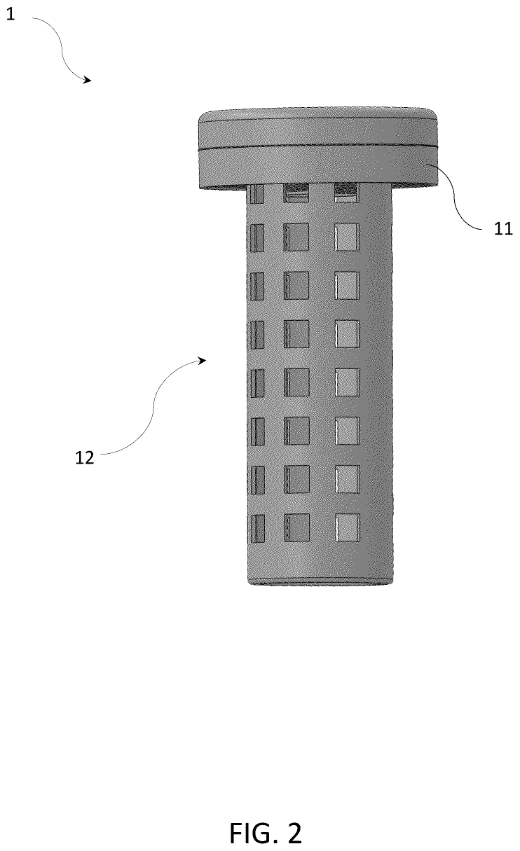

The gravity filter cap 1, referring to FIG. 3 and FIG. 4, comprises a bottle cap 11 and a filter arrangement 12. The bottle cap 11 comprises a ring shaped ceiling wall 111 having a cap opening 112, a circular outer rim 113 integrally extended from a circular outer edge of the ceiling wall 111 and configured to be mounted on the bottle opening 22 of the water bottle 2.

The bottle cap 11 can be configured to sealingly mounted on the bottle opening 22 formed in a bottle neck 23 of the water bottle 2 in usual way such as plugged in, snapped on, screwed on, and etc. According to the preferred embodiment of the present invention, the bottle cap 11 is embodied as screwing on the bottle neck 23 to cover the bottle opening 22, wherein a free end of the tubular bottle neck 23 has a threaded portion and the circular inner surface of the outer rim 113 of the bottle cap 11 also has a correspondingly threaded portion 110 configured to be screwed with the threaded portion of the water bottle 2 so as to securely and sealingly mount the bottle cap 11 on the bottle opening 22 of the water bottle 2, as shown in FIG. 4.

The filter arrangement 12 comprises a tubular inner connector 121, an elongated hollow cylindrical cartridge shell 122 and at least one filter element 123.

Referring to FIG. 3 and FIG. 4, the tubular inner connector 121, having a predetermined height higher than a height of the outer rim 113, is integrally, coaxially and inwardly extended around the cap opening 112 of the bottle cap 11 to define a water outlet 1211 of the bottle cap 11 and form a circular outer mounting surface 1212 thereon.

The elongated hollow cylindrical cartridge shell 122 comprises a first end wall 1221 at a first end thereof, a second end wall 1222 at a second end thereof, a tubular secure head 1223 inwardly formed and extended from the second end wall 1222 and configured to be detachably and sealedly connected with the inner connector 121 so as to coaxially couple the cartridge shell 122 with the bottle cap 11, and a tubular surrounding shell body 1224 extending between the first end wall 1221 and second end wall 1222 thereof and defining a water inlet 1225, having a plurality of surrounding water holes 1226 spacedly and radially formed around the surrounding shell body 1224 of the cartridge shell 122 and a receiving chamber 1227 extending between the first end wall 1221 and the second end wall 1222 inside the cartridge shell 122 and communicating with outside through the plurality of water holes 1226 in such a manner that a water 24 contained in the water bottle to enter the receiving chamber 1227 via the plurality of surrounding water holes 1226, such that when the secure head 1223 of the cartridge shell 122 is connected with the inner connector 121 of the bottle cap 11, the water outlet 1211 of the bottle cap 11 is coaxially aligned with the cap opening 112 (as shown in FIG. 4).

A circular inner mounting surface 12231 is formed in said secure head 1223 to engage with the outer mounting surface 1212 so as to sealingly and securely connect said secure head 1223 with the inner connector 121. According to the preferred embodiment, as shown in FIG. 3, both the outer mounting surface 1212 and inner mounting surface 12231 are threaded portions respectively for screwing with each other.

The cartridge shell 122 can be made of a tubular net form, having a circular diameter smaller than a diameter of the out rim 112 of the bottle cap 11, by rigid material such as plastic, aluminum, alloy and the like, or soft material such as rubber as long as the second end wall 1222 and the secure head 1223 are made of rigid material. According to the preferred embodiment, the cartridge shell 122 has a cylindrical hollow configuration made of plastic molding, wherein the plurality of water holes 1226 of the water inlet 1225 are integrally formed around the hollow cylindrical tubular surrounding shell body 1224. The secure head 1223 is a circular ring which is inwardly protruded around a center hole formed in the first end wall 1222 and has a threaded portion 1228 for being fittingly screwed to the outer mounting surface 1212, embodied as a threaded surface, of the inner connector 121 of the bottle cap 11, so as to securely connect the cartridge shell 122 with the bottle 11 through the inner connector 121, wherein the wall of the inner connector 121 and the wall of the secure head 1223 are overlappedly engaged with each other that substantially strengthens the configuration of the filter arrangement and provides a rigid base to assist the positioning of the at least one filter element 123.

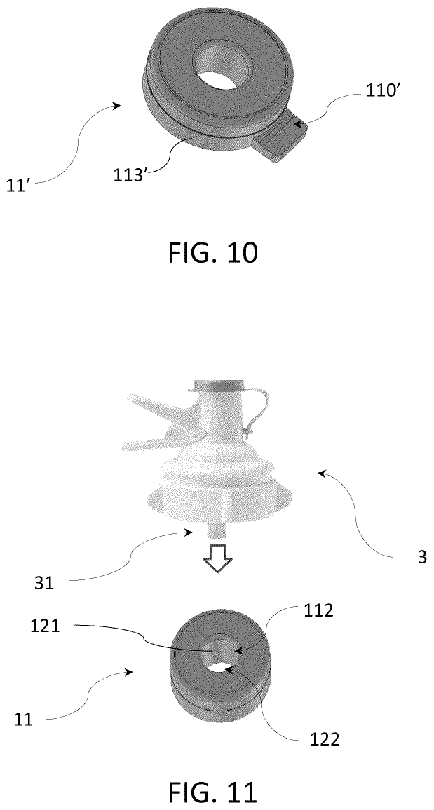

According to the preferred embodiment, the water outlet 1211 is an outlet channel extending along the inner connector 121 which can have a length shorter, equal to or longer than a length of an insert tube 31 of a dispenser faucet 30 as shown in FIG. 11, such that when the insert tube 31 is inserted into the water outlet 1211 via the cap opening 112, the insert tube 31 can be extended toward the receiving chamber 1226 of the cartridge shell 122.

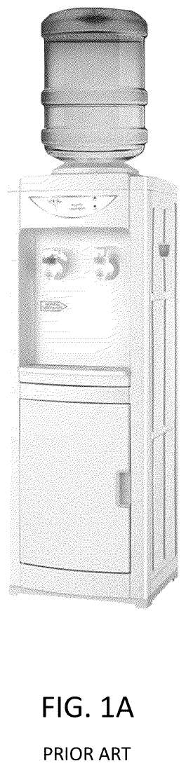

The gravity filter cap 1 of the present invention can also be used as a water bottle cap to cover the bottle opening 22 of the water bottle 2 when there is no filter element 123 disposed in the cartridge shell 122. Instead, a ball stopper 124, having a diameter larger than a diameter of the water outlet 1211 of the inner connector 121 of the bottle cap 11, is received in the receiving chamber 1227 of the cartridge shell 122 and a cover lip 125 can be used to sealedly cover the water outlet 1211, so that the water supplier can simply use the gravity filter cap 1 of the present invention to cover the water bottle 2 and deliver to the user. Then, when the water bottle 2 is placed up-side-down by the user in an inverted or slope-downward dispensing position, the ball stopper 124 is pressed by the water 24 contained in the water bottle 2 to close the water outlet 1211 so that the user may remove the cover lop 125 and place the water bottle on the dispenser device as shown in FIG. 1A or on the dispenser stand as shown in FIG. 1B.

Of course, when the user would like to have a filtration capability for the gravity filter cap 1 of the present invention, the user may simply unscrew the gravity filter cap 1 from the bottle opening 22 and detach the cartridge shell 122 from the bottle cap 11 and place the filter element 123 in the receiving chamber 1227 of the cartridge shell 122. Then, by rescrewing the gravity filter cap 1 of the present invention to the bottle outlet 22, the water 24 in the water bottle 2 will be filtered before dispensing. To replace the filter element 123, such procedures can be repeated to do so.

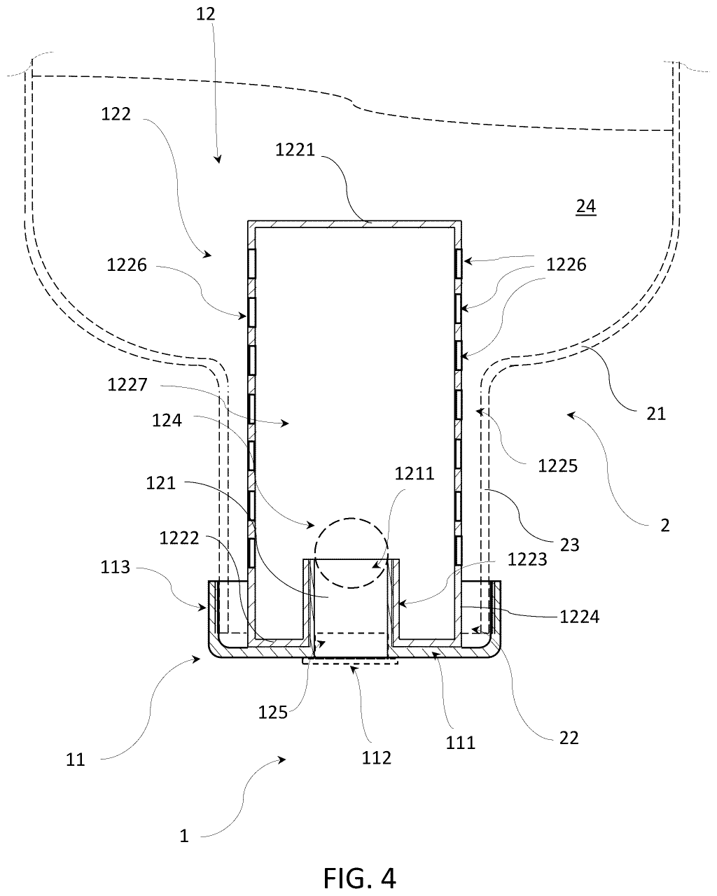

Referring to FIG. 5A to FIG. 5C, various filter elements 123 are illustrated that is configured to be received and disposed in the receiving chamber 1227 of the cartridge shell 122. The at least one filter element 123A is embodied as a sediment filter, for example made of polypropylene, having a cylindrical shape and an inner through hole 1231A. An outer diameter of the filter element 123A and a height of the filter element are smaller than that of the receiving chamber 1227 so as to be received therein.

Referring to FIG. 5B, the filter element 123 is embodied as a string wound filter 123B, which also has a cylindrical shape and an inner through hole 1231B. An outer diameter of the filter element 123B and a height of the filter element are smaller than that of the receiving chamber 1227 so as to be received therein.

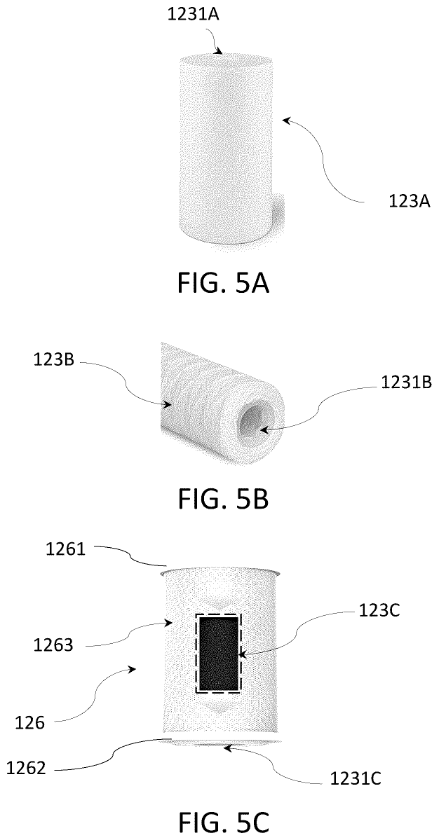

As shown in FIG. 6, when a diameter of the through hole 1231A, 123B of the equal to or slightly larger than an outer diameter of the secure head 1223 of the cartridge shell 122 and a heigh of the filter element 123A, 123B is equal to a height of the receiving chamber 1227, a ring shape recess 1228 formed between the shell body 1225 and the secure head 1223 configures a means for holding the filter element 123A, 123B in position, wherein when the diameter of the through hole 1231A, 1231B of the filter element 123A, 123B is slightly smaller than the outer diameter of the secure head 1223, the secure head 1223 allows the filter element 123A, 123B being sleeved tightly with the secure head 1223 to sealingly couple the filter element 123A, 123B around the water outlet 1221 coaxially that the water outlet 1221 only communicates with the through hole 1231A, 1231B of the filter element 123A, 123B, such that only water 24 in the water bottle 2 entered the cartridge shell 122 through the water holes 1226 of the water inlet 1225 being filtered by the filter element 123A, 123B can enter the through hole 1231A, 1231B and dispense through the water outlet 1221 and the cap opening 112. The ball stopper 124 can be disposed inside the through hole 1231A and shut the water outlet 1211 by the pressure of the filtered water in the through hole 1231A, 1231B. When the insert tube 31 (as shown in FIG. 11) of the dispenser faucet 3 is inserted into the water outlet 1211 of the inner connector 121, the insert tube 31 can push up the ball stopper 124 to open the water outlet 1211 to dispense filtered water through the dispenser faucet 3.

It is worth mentioning that a ring-shape sealer 127, such as made of elastic material, rubber or other sealing material, can be placed between the filter element 123A, 123B and the secure head 1223 to enhance the sealing effect.

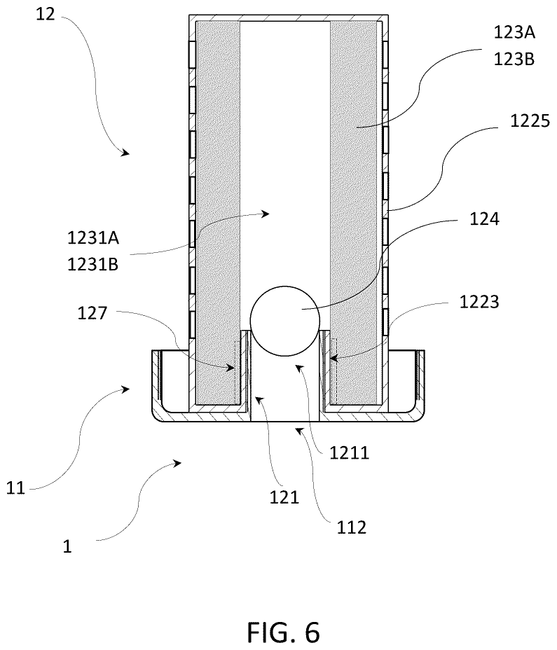

As shown in FIG. 7, when a diameter of the through hole 1231A, 1231B of the filter element 123A, 123B is smaller than the water outlet 1211 of the inner connector 121 of the bottle cap 11 and a height of the filter element 123A, 123B is shorter than a height of the receiving chamber 1227, the ball stopper 124 is functioned as the means for holding the filter element 123A by disposing between the first end wall 1221 of the cartridge shell 122 and the filter element 123A, 123B in position. Of course, other presser or holder such as a spring or an elastic member can be used to substitute the ball stopper to press the filter element 123A, 123B against the secure head 1223 of the cartridge shell 122, wherein the secure head 1223 can be made with in predetermined thickness to provide more supporting surface for one end of the filter element 123A, 123B to press against to ensure a sealing and coupling effect.

Referring to FIG. 5C, the filter arrangement 2 according to the preferred embodiment of the present invention further comprises a filter cartridge 126 configured to contain the at least one filter element 123 therein and be mounted in the receiving chamber 1227 in a filtering position, wherein the filter element 123 may be a plurality of ceramic particles, polypropylene particles, paper filter, string wound filter or other filtration material. According to the preferred embodiment of the present invention the filter element is embodied as activated carbon charcoal 123C filled in the filter cartridge 126. The filter cartridge 1230 comprises a first end member 1261, a second end member 1262, and a hollow filter body 1263, made of water permeable material, mounted between the first end member 1261 and the second end member 1262 to receive the activated carbon charcoal filter element 123C therein (shown within the broken lines window of FIG. 5C). The filter cartridge 126 further has an inner through hole 1231C having a diameter that can be larger or smaller than the water outlet 1211 of the inner connector 121 of the bottle cap 11 while an outer diameter of the filter cartridge 126 is smaller than or equal to an inner diameter of the receiving chamber 1227 of the cartridge shell 122.

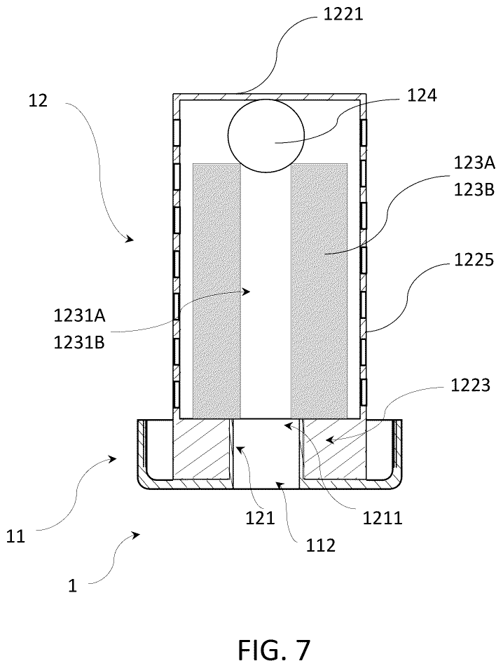

Referring to FIG. 8, the filter cartridge 126 has a diameter and a height smaller than the receiving chamber 1227 of the cartridge shell 122 so as to be received therein. The second end member 1262 has a holder member 1261, which is embodied as an insert rim, outwardly protruded and sized to be fittingly inserted into the water outlet 1211 of the inner connector 121 of the bottle cap 11 to function as the means for holding the filter cartridge 126 in position inside receiving chamber 1227. Further, the ring shape sealer 127 can be placed between the holder member 12621 and the inner connector 121 to enhance the sealing effect. In other words, the means for holding the filter cartridge 126 (i.e. the filter element 123C) in position inside the receiving chamber 1227 includes the inner connector 1211 and the holder member 12621 tightly inserted in the inner connector 1211 so as to sealingly couple the filter element 123C coaxially with the inner connector 1211 and the water outlet 1221 thereof that the water outlet 1221 only communicates with the through hole 1231C surrounded by the filter element 123C, such that only water 24 in the water bottle 2 entered the cartridge shell 122 through the water holes 1226 of the water inlet 1225 being filtered by the filter element 123C (activated carbon charcoal) can enter the through hole 1231C and dispense through the water outlet 1221 and the cap opening 112.

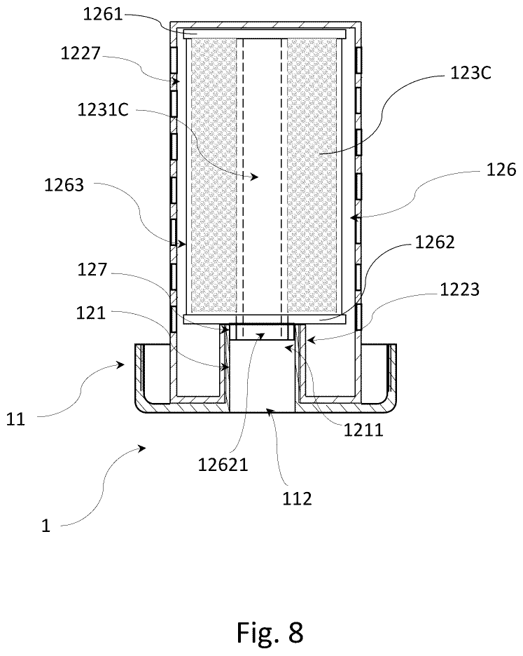

Referring to FIG. 9, an alternative mode of the holder member 12621 which is embodied as a holding sleeve protruded from the second end member 1262 of the filter cartridge 126 having an inner diameter equal to or slightly larger than an outer diameter of the secure head 1223 so that the filter cartridge 126 can be held in position inside the receiving chamber 1227 sleeving the holder member 12621 around the secure head 1223. In other words, the means for holding the filter cartridge 126 (i.e. the filter element 123C) in position inside the receiving chamber 1227 includes the holder member 12621 and the secure head 1223 which is tightly inserted in the holder member 12621 so as to sealingly couple the filter element 123C coaxially with the secure head 1223 and the water outlet 1221 of the inner connector 122 that the water outlet 1221 only communicates with the through hole 1231C surrounded by the filter element 123C, such that only water 24 in the water bottle 2 entered the cartridge shell 122 through the water holes 1226 of the water inlet 1225 being filtered by the filter element 123C (activated carbon charcoal) can enter the through hole 1231C and dispense through the water outlet 1221 and the cap opening 112. Similarly, the ring shape sealer 127 can be placed between the holder member 12621 and the secure head 1223 to enhance the sealing effect.

In view of above, as illustrated in FIG. 2 to FIG. 9A, the gravity filter cap 1 according to the preferred embodiment, of the present invention further comprises a means for holding the at least one filter element 123 in position within the receiving chamber 1227 of the cartridge shell 122 in such a manner that one end of the at least one filter element 123 is securely coupled with the water outlet 1211 of bottle cap 11 to ensure the water entered through the water inlet 1225 of the cartridge shell 122 to pass through the at least one filter element 123 and dispense through the water outlet 1211 of the bottle cap 11 when the water bottle 2 is in the inverted or slop-downward dispensing position, thereby the gravity filter cap 1 is arranged correspondingly in a dispensable condition (as shown in FIG. 4) that the bottle opening 22 is directed downward and the filter arrangement 12 is upwardly extended from the bottle cap 11 to ensure the filter arrangement 12 being immersed in the water 24 around the filter arrangement 12 which is forced by gravity to pass through the at least one filter element 123 to be filtered before dispensing through the water outlet 1211 of the cartridge shell 122 and the cap opening 112 of the bottle cap 11.

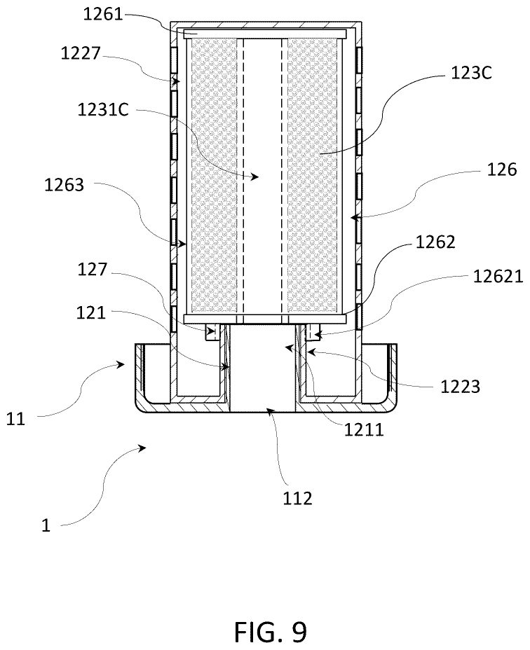

Referring to FIG. 10, an alternative mode of the bottle cap 11′ is illustrated, which configured to be snapped on the bottle neck 23 of the water bottle 2 so as to securely cover the bottle opening 22, wherein a pulling tab 110′ is radially and outwardly protruded from the outer rim 113′ for ease of the user to grip and pull to detach the bottle cap 11′ from the water bottle 2.

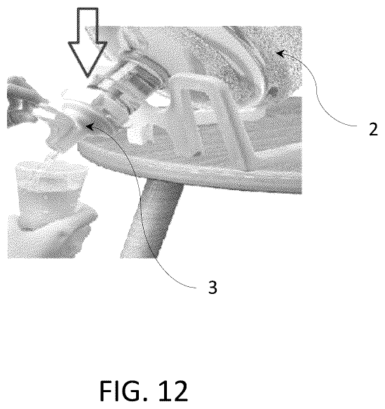

Referring to FIG. 11, the gravity filter cap 1 may further comprise the dispenser faucet 3 configured to be sealedly connected to the bottle cap 11 by fittingly inserting the insert tube 31 in the inner connector 122 of the bottle cap 11, so as to selectively normally close the cap opening 112 and open the cap opening 112 to dispense the water 24 contained in the water bottle 2 to flow out through the cap opening 112 and the dispenser faucet 3, as shown in FIG. 12. It is worth mentioning that the gravity filter cap 1 of the present invention is able to be equipped with all kinds of dispenser faucet 3.

It is worth mentioning that when an outer enclosure shell body is provided for the filter element 123, as shown in FIG. 5A to FIG. 5C, it can be functioned as the cartridge shell 122 while the stopper 124 is positioned to close one end of the through hole 1231 (1231A, 1231B, 1231C) and the other end of the through hole 1231 is connected with the secure head 1223 to communicate with the water outlet 123 and the cap opening 112.

It is appreciated that the gravity filter cap 1 can be used as an independently for the user to replace the original bottle cap come with the water bottle so as to provide a method of filtering and dispensing water contained in the water bottle 2, comprising steps of:
(a) providing the bottle cap 11 of the gravity filter cap 1 at the bottle opening 22 of the water bottle 2 which is directed downward allowing the water 24 contained in the water bottle 2 trending to flow out through the bottle opening 22;
(b) aligning the water outlet 1211 of the filter arrangement 122 of the gravity filter cap 1 with the cap opening 112 coaxially aligned with the bottle opening 22; and
(c) holding the at least one filter element 123 against the water outlet 1211 to ensure the water 24 contained in the water bottle 2 to enter the at least one filter element 123 through the water inlet 1225 which has the plurality of surrounding holes 1226 spacedly formed around the circular surrounding shell body 1224 of the elongated cylindrical cartridge shell 122 of the at least one filter element 123 and be forced to pass through the at least one filter element 123 due to gravity before dispensing the water 24 o contained in the water bottle 2 via the water outlet 1211, the cap opening 112 and the bottle opening 22.

According to the preferred embodiment, the method further comprises a step of controlling a flow of water 24 contained in the water bottle 2 via the cap opening 112 by the dispenser faucet 3 mounted to the bottle cap 11 of the gravity filter cap 1.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A gravity filter cap, adapted for a water bottle which comprises a bottle body having a bottle opening, comprising:
a bottle cap comprising a ring shaped ceiling wall having a cap opening, a circular outer rim integrally extended from a circular outer edge of said ceiling wall and configured for mounting on the bottle opening of the water bottle; and
a filter arrangement comprising:
a tubular inner connector integrally and inwardly extended around said cap opening of said bottle cap to define a water outlet of said bottle cap therein;
an elongated hollow cylindrical cartridge shell comprising:
a first end wall at a first end thereof,
a second end wall at a second end thereof,
a tubular secure head inwardly formed and extended from said second end wall and configured to be detachably and sealedly connected with said inner connector so as to coaxially couple said cartridge shell with said bottle cap, and
a tubular surrounding shell body extending between said first end and said second end and defining a water inlet, which has a plurality of surrounding water holes spacedly and radially formed around said surrounding shell body, and a receiving chamber extending between said first end wall and said second end wall inside said cartridge shell and communicating with outside through said plurality of water holes in such a manner that a water contained in the water bottle to enter said receiving chamber via said plurality of surrounding water holes, such that when said secure head is connected with said inner connector of said bottle cap, said water outlet of said cartridge shell is coaxially aligned with said cap opening;
at least one filter element disposed in said receiving chamber of said cartridge shell; and
means for holding said at least one filter element in position within said receiving chamber of said cartridge shell in such a manner that one end of said at least one filter element is securely coupled with said water outlet of said bottle cap to ensure the water entered through said water inlet of said cartridge shell to pass through said at least one filter element and dispense through said water outlet of said bottle cap when the water bottle is in an inverted or slop-downward dispensing position, thereby said gravity filter cap is arranged correspondingly in a dispensable condition that the bottle opening is directed downward and said filter arrangement is upwardly extended from said bottle cap to ensure said filter arrangement being immersed in the water around said filter arrangement which is forced by gravity to pass through said at least one filter element to be filtered before dispensing through said water outlet of said cartridge shell and said cap opening of said bottle cap.

2. The gravity filter cap, as recited in claim 1, wherein said water outlet is an outlet channel defined by said inner connector of said bottle cap and coaxially extended from said cap opening of said bottle cap into said receiving chamber of said cartridge shell via said inner connector when said bottle cap is securely connected with said cartridge shell.

3. The gravity filter cap, as recited in claim 1, wherein said holding means comprises a holder member configured to securely couple one end of said at least one filter element with said water outlet of bottle cap for ensuring the water entered through said water inlet of said cartridge shell to pass through said at least one filter element and dispense through said water outlet of said bottle cap.

4. The gravity filter cap, as recited in claim 2, wherein said holding means comprises a holder member configured to securely couple one end of said at least one filter element with said water outlet of bottle cap for ensuring the water entered through said water inlet of said cartridge shell to pass through said at least one filter element and dispense through said water outlet of said bottle cap.

5. The gravity filter cap, as recited in claim 1, wherein a ring shape recess is formed between said shell body and said secure head to configure as said holding means to hold one end portion of said at least one filter therein.

6. The gravity filter cap, as recited in claim 5, wherein said at least one filter element, having a cylindrical shape and an inner through hole, is configured to be sleeved tightly with said secure head to sealingly couple one end portion of said at least one filter element around said water outlet coaxially to ensure said water outlet only communicating with said inner through hole of said at least one filter element.

7. The gravity filter cap, as recited in claim 5, wherein said filter arrangement further comprises a ring-shape sealer being placed between said at least one filter element and said secure head.

8. The gravity filter cap, as recited in claim 2, wherein a ring shape recess is formed between said shell body and said secure head to configure as said holding means to hold one end portion of said filter cartridge.

9. The gravity filter cap, as recited in claim 8, wherein said filter cartridge, having a cylindrical shape and an inner through hole, is configured to be sleeved tightly with said secure head to sealingly couple said filter cartridge with said water outlet coaxially to ensure said water outlet only communicating with said inner through hole of said filter cartridge.

10. The gravity filter cap, as recited in claim 9, wherein said filter arrangement further comprises a ring-shape sealer being placed between said filter cartridge and said secure head.

11. The gravity filter cap, as recited in claim 1, wherein said filter arrangement further comprises a filter cartridge containing said at least one filter element and mounting in said receiving chamber in a filtering position, wherein said filter cartridge comprises a first end member, a second end member and a hollow filter body mounted between said first end member and said second end member to receive said at least one filter element therein, wherein said filter cartridge has an inner through hole to communicate with said water outlet of said inner connector of said bottle cap.

12. The gravity filter cap, as recited in claim 11, wherein said holding means includes said inner connector and a holder member which is an insert rim protruded from said second end member of said filter cartridge and sized to be fittingly inserted into said water outlet of said inner connector of said bottle cap so as to hold said filter cartridge and said at least one filter element received therein in position inside said receiving chamber of said cartridge shell.

13. The gravity filter cap, as recited in claim 12, wherein said filter arrangement further comprises a ring-shape sealer being placed between said holder member and said inner connector.

14. The gravity filter cap, as recited in claim 11, wherein said holding means includes said secure head and a holder member which is a holding sleeve protruded from said second end member of said filter cartridge and sized to be fittingly sleeved around said secure head of said cartridge shell so as to hold said filter cartridge and said at least one filter element received therein in position inside said receiving chamber of said cartridge shell.

15. The gravity filter cap, as recited in claim 14, wherein said filter arrangement further comprises a ring-shape sealer being placed between said holder member and said secure head.

16. The gravity filter cap, as recited in claim 1, wherein a circular outer mounting surface is formed on said inner connector and said secure head has a circular inner mounting surface configured to securely and sealingly engage with said outer mounting surface of said inner connector to coaxially couple said cartridge shell with said bottle cap.

17. The gravity filter cap, as recited in claim 1, further comprising a dispenser faucet configured to be sealedly connected to said bottle cap to selectively normally close said cap opening and open said cap opening to dispense the water contained in the water bottle to flow out through said cap opening and said dispenser faucet.

18. The gravity filter cap, as recited in claim 17, wherein said dispenser faucet comprises an insert tube fittingly inserted in said inner connector of said bottle cap.

19. A method of filtering and dispensing water contained in a water bottle, comprising:
(a) providing a bottle cap of a gravity filter cap at a bottle opening of the water bottle which is directed downward allowing a water contained in said water bottle trending to flow out through said bottle opening;
(b) aligning a water outlet of a filter arrangement of said gravity filter cap with a cap opening coaxially aligned with said bottle opening; and
(c) holding at least one filter element against said water outlet to ensure the water contained in said water bottle entering said filter arrangement through a water inlet which has a plurality of surrounding holes spacedly formed around a circular surrounding shell body of an elongated cylindrical cartridge shell of said filter arrangement and be forced to pass through said at least one filter element due to gravity before dispensing the water contained in said water bottle via said water outlet, said cap opening and said bottle opening.

20. The method, as recited in claim 19, further comprising a step of controlling a flow of water contained in said water bottle via said cap opening by a dispenser faucet mounted to said bottle cap of said gravity filter cap.

21. A gravity filter cap, adapted for a water bottle which comprises a bottle body having a bottle opening, comprising:
a bottle cap comprising a ring shaped ceiling wall having a cap opening, a circular outer rim integrally extended from a circular outer edge of said ceiling wall and configured for mounting on the bottle opening of the water bottle; and
a filter arrangement comprising:
a tubular inner connector integrally and inwardly extended around said cap opening of said bottle cap to define a water outlet of said bottle cap therein;
at least one filter element, which is connected with said inner connector, comprising an outer enclosure shell body and has an inner through hole which has one end communicating with said water outlet and said cap opening; and
a stopper positioned to close another end of said through hole of said at least one filter element, thereby said gravity filter cap is arranged correspondingly in a dispensable condition that the bottle opening is directed downward and said filter arrangement is upwardly extended from said bottle cap to ensure said filter arrangement being immersed in the water around said filter arrangement which is forced by gravity to pass through said at least one filter element to be filtered before dispensing through said water outlet of said cartridge shell and said cap opening of said bottle cap.

22. The gravity filter cap, as recited in claim 21, wherein said at least one filter element, having a cylindrical shape, is configured to be sleeved around said inner connector to sealingly couple one end portion of said at least one filter element around said water outlet coaxially to ensure said water outlet only communicating with said inner through hole of said at least one filter element.

23. The gravity filter cap, as recited in claim 22, further comprising a dispenser faucet configured to be sealedly connected to said bottle cap to selectively normally close said cap opening and open said cap opening to dispense the water contained in the water bottle to flow out through said cap opening and said dispenser faucet.
